(19) United States
(12) Patent Application Publication
(10) Pub. No.: US 2024/0303308 A1
(43) Pub. Date: Sep. 12, 2024

(54) ENHANCED SEQUENTIAL BIOMETRIC VERIFICATION

(71) Applicant: Ademco Inc., Golden Valley, MN (US)

(72) Inventors: Maoding SU, Shanghai (CN); Yanqing YANG, Shanghai (CN); Yekun GAO, Shanghai (CN)

(21) Appl. No.: 18/262,081

(22) PCT Filed: Jan. 22, 2021
(86) PCT No.: PCT/CN2021/073184

§ 371 Date: Jul. 19, 2023

(51) Int. Cl. G06F 21/32

(52) U.S. Cl. CPC G06F 21/32

(57) ABSTRACT

This disclosure is directed to a sequential biometric verification system and process. A device receives (502) a first biometric input and determines a match with a first predetermined biometric input of a verification sequence. The device provides (504) a first prompt that includes a request for a next biometric input user selection or a complete verification sequence user selection. The device receives the next biometric input user selection in response to the first prompt and a second biometric input, and then determines a match with a second predetermined biometric input of a verification sequence. The device provides a second prompt. The device receives the complete verification sequence user selection in response to the second prompt. Upon determining that at least the first and second biometric inputs (508) and the order of inputs match the predetermined biometric inputs of the verification sequence (510), the device enables receiving a user command.

### TECHNICAL FIELD

The disclosure relates to security systems that utilize biometric verification.

### BACKGROUND

Fingerprint recognition to grant a user authorized access to a computing device is a popular security tool. This technology could be added to security panels to make arming or disarming the security panel more convenient. However, current fingerprint recognition technology still includes some security risk where fake fingerprints can fool the fingerprint sensor. Most applications only recognize a single fingerprint, and if this fingerprint matches the stored fingerprint, the device will grant the user authorization to access the device. This may not be safe enough for some high-level security requirements.

### SUMMARY

In general, the disclosure provides a sequential biometric verification process to enhance the security level of a panel with fingerprint sensor. Rather than simply requesting a single biometric verification, or asking for particular biometric information for verification, a computing device receives, open-endedly, a number of biometric inputs from a user. That particular user has a predefined sequence of varying biometric inputs, ranging from specific fingers on specific hands to facial or ocular recognition or any other biometric input suitable for the device in which the verification process is implemented, as their passcode, of sorts. After each biometric input, the computing device prompts the user for whether the user wishes to provide more biometric inputs or if the user believes the sequence is complete. As the user wishes to provide more biometric inputs, the user selects the option within the prompt to provide more biometric inputs, and the computing device receives those inputs. The computing device receives a selection of the completion of the input process. If the computing device determines that each biometric input matches an expected, predetermined biometric input in the valid sequence (i.e., both that the provided biometric input meets a validity threshold in comparison to the stored biometric input and that the order of biometric inputs provided is the same as the order provided in the valid sequence), then the computing device may provide access to the user.

In one example, the disclosure is directed to a method in which a computing device receives, from a user, a first biometric input. The method further includes determining that the first biometric input matches a first predetermined biometric input of a verification sequence. The method also includes, after receiving the first biometric input at the computing device, providing a first prompt to the user, the first prompt including a first request for at least one of a next biometric input user selection and a complete verification sequence user selection. The method further includes receiving, from the user, the next biometric input user selection in response to the first prompt. The method also includes receiving, from the user, a second biometric input at the computing device. The method further includes determining that the second biometric input matches a second predetermined biometric input of a verification sequence. The method also includes, after receiving the second biometric input at the computing device, providing a second prompt to the user, the second prompt including a second request for at least one of the next biometric input user selection and the complete verification sequence user selection. The method further includes receiving, from the user, the complete verification sequence user selection in response to the second prompt. The method also includes after i) receiving the complete verification sequence user selection, and ii) upon determining that at least the first biometric input matches the first predetermined biometric input of the verification sequence, the second biometric input matches the second predetermined biometric input of the verification sequence, and an order in which the first biometric input and the second biometric input is received matches a predetermined biometric input order for the first biometric input and the second biometric input required by the verification sequence, enabling the computing device to receive a user command.

In another example, the disclosure is directed to a non-transitory computer-readable storage medium containing instructions. The instructions, when executed, cause one or more processors to receive, by one or more processors of the computing device, a first biometric input. The instructions, when executed, further cause one or more processors to determine, by the one or more processors of the computing device, that the first biometric input matches a first predetermined biometric input of a verification sequence. The instructions, when executed, also cause one or more processors to after receiving the first biometric input, provide, by the one or more processors of the computing device, a first prompt, the first prompt including a first request for at least one of a next biometric input user selection and a complete verification sequence user selection. The instructions, when executed, further cause one or more processors to receive, by the one or more processors of the computing device, the next biometric input user selection in response to the first prompt. The instructions, when executed, also cause one or more processors to receive, by the one or more processors of the computing device, a second biometric input. The instructions, when executed, further cause one or more processors to determine, by the one or more processors of the computing device, that the second biometric input matches a second predetermined biometric input of a verification sequence. The instructions, when executed, also cause one or more processors to after receiving the second biometric input, provide, by the one or more processors of the computing device, a second prompt to the user, the second prompt including a second request for at least one of the next biometric input user selection and the complete verification sequence user selection. The instructions, when executed, further cause one or more processors to receive, by the one or more processors of the computing device, the complete verification sequence user selection in response to the second prompt. The instructions, when executed, also cause one or more processors to, after i) receiving, by the one or more processors of the computing device, the complete verification sequence user selection, and ii) upon determining, by the one or more processors of the computing device, that at least the first biometric input matches the first predetermined biometric input of the verification sequence, the second biometric input matches the second predetermined biometric input of the verification sequence, and an order in which the first biometric input and the second biometric input is received matches a predetermined biometric input order for the first biometric input and the second biometric input required by the verification sequence, enable, by the one or more processors of the computing device, receipt of a user command.

In another example, a computing device is configured to receives, from a user, a first biometric input. The computing device is further configured to determine that the first biometric input matches a first predetermined biometric input of a verification sequence. The computing device is further configured to, after receiving the first biometric input at the computing device, provide a first prompt to the user, the first prompt including a first request for at least one of a next biometric input user selection and a complete verification sequence user selection. The computing device is further configured to receive, from the user, the next biometric input user selection in response to the first prompt. The computing device is further configured to receive, from the user, a second biometric input at the computing device. The computing device is further configured to determine that the second biometric input matches a second predetermined biometric input of a verification sequence. The computing device is further configured to, after receiving the second biometric input at the computing device, provide a second prompt to the user, the second prompt including a second request for at least one of the next biometric input user selection and the complete verification sequence user selection. The computing device is further configured to receive, from the user, the complete verification sequence user selection in response to the second prompt. The computing device is further configured to after i) receiving the complete verification sequence user selection, and ii) upon determining that at least the first biometric input matches the first predetermined biometric input of the verification sequence, the second biometric input matches the second predetermined biometric input of the verification sequence, and an order in which the first biometric input and the second biometric input is received matches a predetermined biometric input order for the first biometric input and the second biometric input required by the verification sequence, enable the computing device to receive a user command.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example system that includes a computing device, one or more sensors, and a user interface component configured to output one or more prompts for one or more biometric inputs, in accordance with one or more techniques of this disclosure.

FIG. 2 is a block diagram illustrating a more detailed example of a computing device configured to perform the techniques described herein.

FIG. 3 is a conceptual diagram illustrating a sequence of biometric inputs, in accordance with one or more techniques of this disclosure.

FIG. 4 is a flowchart illustrating an example biometric authorization technique in accordance with the techniques described herein.

FIG. 5 is a flow chart illustrating an example biometric authorization technique in accordance with the techniques described herein.

### DETAILED DESCRIPTION

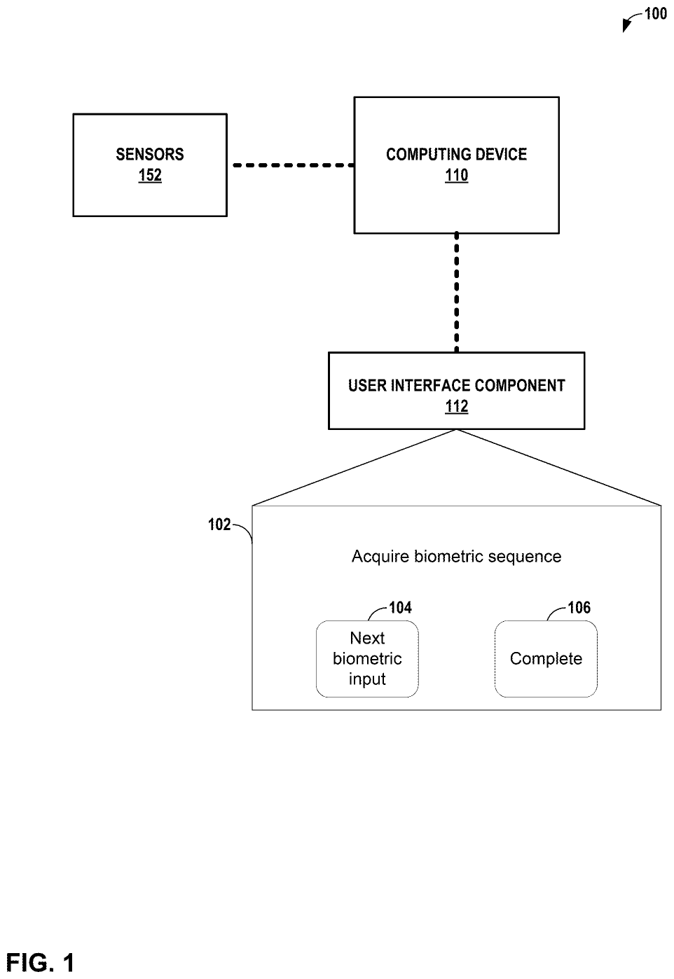

FIG. 1 is a block diagram illustrating an example system 100 that includes a computing device 110, one or more sensors 152, and a user interface (UI) component 112 configured to output one or more prompts 102 for one or more biometric inputs, in accordance with one or more techniques of this disclosure. As shown in FIG. 1, computing device 110 may be communicatively connected to each of sensors 152 and UI component 112. In some instances, one or more of sensors 152 and UI component 112 may be physically integrated into computing device 110, while other instances may include one or more of sensors 152 and UI component 112 being separate components that communicate to computing device 110 over a wired or wireless connection.

Computing device 110 may be any computer with the processing power required to adequately execute the techniques described herein. For instance, computing device 110 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

Sensors 152 may include one or more biometric sensors (e.g., fingerprint sensors, retina scanners, vocal input sensors/microphones, facial recognition sensors, cameras) configured to receive user input in the form of a biometric signature from a user and transmit the biometric input to computing device 110 for processing. Computing device 110 may further include sensors 152 in the form of one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a heart rate sensor, magnetometer, glucose sensor, olfactory sensor, compass sensor, or a step counter sensor.

UI component 112 may be any visual or audible input/output (I/O) component that may be configured to output information to or receive input from a user. For instance, UI component 112 may be a screen, either touch or otherwise, that may display prompt 102 to a user and receive a selection of either selection 104 or selection 106. UI component 112 may also be speakers that output prompt 102 as an audible prompt.

The techniques of this disclosure describe a user-defined fingerprint (or other biometric) sequence to enhance the security level of a computing device (e.g., a security panel) with the necessary sensors that may read the requisite biometric information. For instance, computing device 110 may include a user-facing security option to disable security, to require only a single biometric signature to authorize a command, or may require a sequence of biometric signatures to authorize a command. If the user enables the sequence setting, computing device 110 may request several biometric inputs in order to complete the biometric acquisition step, requiring both the correct biometric signature and the correct sequence to grant the access.

When the user enables the sequence option, computing device 110 may allow the user to input a preferred biometric sequence to initially set the predetermined biometric input verification sequence. If sensors 152 detect a valid biometric input (e.g., one of a fingerprint scan, a facial recognition scan, a retinal scan, or a vocal input), computing device 110 may prompt the user to input a next biometric input or complete the input. In some instances, the user may be limited to a certain number of biometric inputs (e.g., ten), or a particular number of different biometric inputs (e.g., two retinal scans, ten different fingerprints, a single facial recognition scan, etc.) to complete predetermined biometric sequence.

After computing device 110 receives an indication that the predetermined biometric verification sequence is complete, computing device 110 may either store the verification sequence in a data store and associate the sequence with a particular user or request that the user repeat the sequence to verify the sequence prior to storing the verification sequence in the data store.

At a later time, when the user needs to access computing device 110, computing device 110 may issue prompt 102 to the user. Sensors 152 may read one or more biometric inputs from the user and transmit those inputs to computing device 110 for analysis. Computing device 110 may continue issuing instances of prompt 102 via UI component 112 to determine whether the user believes the sequence is complete or whether additional biometric inputs are to be submitted. Once computing device 110 receives the indication that the user believes the sequence is complete, computing device 110 may analyze the received biometric inputs to verify that the biometric inputs match the predetermined biometric inputs provided by the user in the definition process and that the order of the provided biometric inputs match the predetermined biometric sequence provided by the user in the definition process. In some examples, computing device 110 may analyze the received biometric inputs as they are input by the user rather than once the full sequence is input.

In accordance with one or more techniques of this disclosure, computing device 110 receives, from a user, a first biometric input at sensors 152. Computing device 110 determines that the first biometric input matches a first predetermined biometric input of a verification sequence. After receiving the first biometric input, computing device 110 provides a first instance of prompt 102 to the user via UI component 112. Prompt 102 includes a first request for at least one of a next biometric input user selection 104 and a complete verification sequence user selection 106.

Computing device 110 receives, from the user, the next biometric input user selection in response to first prompt 102. Computing device 110 receives, from the user, a second biometric input at sensors 152. Computing device 110 determines that the second biometric input matches a second predetermined biometric input of a verification sequence. After receiving the second biometric input, computing device 110 provides a second prompt, which may be another instance of prompt 102, to the user via UI component 112. The second prompt includes a second request for at least one of the next biometric input user selection 104 and the complete verification sequence user selection 106.

Computing device 110 receives, from the user, the complete verification sequence user selection in response to the second prompt. After receiving the complete verification sequence user selection, and upon computing device 110 determining that at least the first biometric input matches the first predetermined biometric input of the verification sequence, the second biometric input matches the second predetermined biometric input of the verification sequence, and an order in which the first biometric input and the second biometric input is received matches a predetermined biometric input order for the first biometric input and the second biometric input required by the verification sequence, computing device 110 provides authorization to receive a user command.

Rather than not allowing fingerprint input at computing device 110, or using a single fingerprint input, computing device 110 utilizes a sequence of biometric inputs to prove an identity of a user, amounting to an open-ended passcode of indeterminate length with each character being a separate biometric input of the user's choosing (although some examples may include a maximum limit on the biometric sequence length). In this way, the sequence of the inputs becomes is important, as opposed to requiring multiple inputs at once (which would require more expensive hardware). Computing device 110 may issue prompt 102 after each fingerprint is important, either via a visual display on UI components 112 or audibly over UI components 112. In examples where computing device 110 is a control panel for a security system, these biometric sequences could be used to arm or disarm the system. It should be noted that computing device 110 may not require biometric authentication for all actions, such as less risky actions (e.g., turning on or off lights, arming the system, etc.).

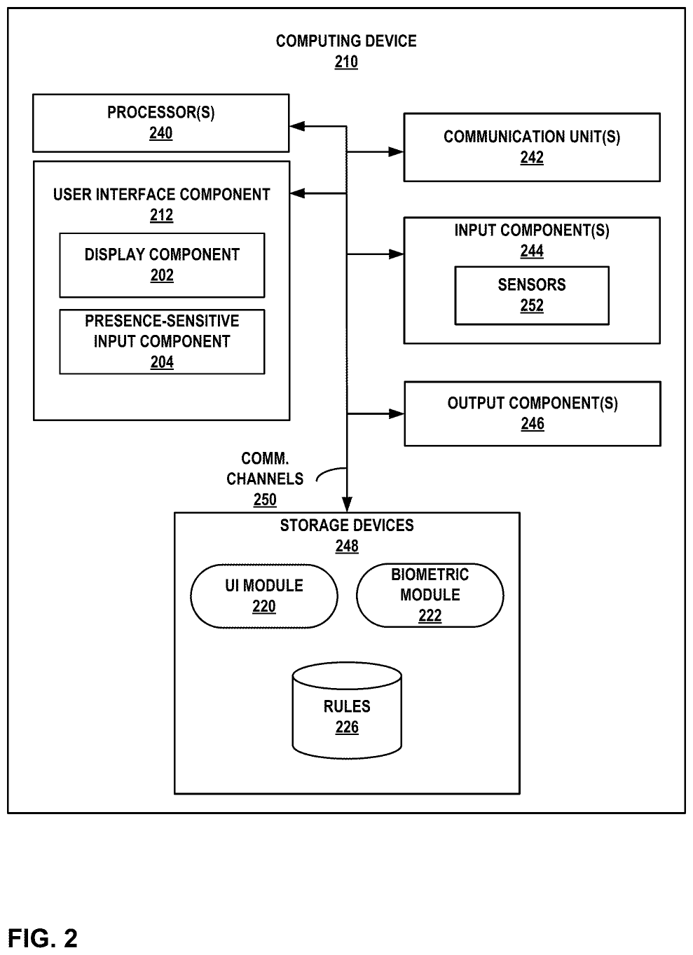

FIG. 2 is a block diagram illustrating a more detailed example of computing device 110, which is configured to perform the techniques described herein. Computing device 210 of FIG. 2 is described below as an example of computing device 110 of FIG. 1. FIG. 2 illustrates only one particular example of computing device 210, and many other examples of computing device 210 may be used in other instances and may include a subset of the components included in example computing device 210 or may include additional components not shown in FIG. 2.

Computing device 210 may be any computer with the processing power required to adequately execute the techniques described herein. For instance, computing device 210 may be any one or more of a mobile computing device (e.g., a smartphone, a tablet computer, a laptop computer, etc.), a desktop computer, a smarthome component (e.g., a computerized appliance, a home security system, a control panel for home components, a lighting system, a smart power outlet, etc.), a wearable computing device (e.g., a smart watch, computerized glasses, a heart monitor, a glucose monitor, smart headphones, etc.), a virtual reality/augmented reality/extended reality (VR/AR/XR) system, a video game or streaming system, a network modem, router, or server system, or any other computerized device that may be configured to perform the techniques described herein.

As shown in the example of FIG. 2, computing device 210 includes user interface device (UID) 212, one or more processors 240, one or more communication units 242, one or more input components 244, one or more output components 246, and one or more storage components 248. UI component 212 includes display component 202 and presence-sensitive input component 204. Storage components 248 of computing device 210 include UI module 220, biometric module 222, and rules data store 226.

One or more processors 240 may implement functionality and/or execute instructions associated with computing device 210 to receive, prompt for, and verify a sequence of biometric inputs to grant access to a user for providing more commands to computing device 210. That is, processors 240 may implement functionality and/or execute instructions associated with computing device 210 to receive, analyze, and prompt for further biometric inputs from a user as a security control procedure.

Examples of processors 240 include application processors, display controllers, auxiliary processors, one or more sensor hubs, and any other hardware configure to function as a processor, a processing unit, or a processing device. Modules 218, 220, 222, and 224 may be operable by processors 240 to perform various actions, operations, or functions of computing device 210. For example, processors 240 of computing device 210 may retrieve and execute instructions stored by storage components 248 that cause processors 240 to perform the operations described with respect to modules 220 and 222 and rules data store 226. The instructions, when executed by processors 240, may cause computing device 210 to receive, prompt for, and verify a sequence of biometric inputs to grant access to a user for providing more commands to computing device 210.

UI module 220 may perform operations managing a user interface (e.g., prompt 102) that computing device 210 provides at UI component 212, for example, for facilitating interactions between a user of computing device 210 and computing device 210 itself. For example, UI module 220 of computing device 210 may receive indications of biometric input via sensors 252 and indications of user inputs in response to prompts output by UI module 220 via UI component 212.

In some examples, biometric module 222 may execute locally (e.g., at processors 240) to provide functions associated with verifying received biometric inputs and the order of the received biometric inputs, as well as granting or denying access to the user to provide further commands to computing device 210. In some examples, biometric module 222 may act as an interface to a remote service accessible to computing device 210. For example, biometric module 222 may be an interface or application programming interface (API) to a remote server that analyzes received biometric inputs and the order of the received biometric inputs, and grants or denies access to the user to provide further commands to computing device 210.

One or more storage components 248 within computing device 210 may store information for processing during operation of computing device 210 (e.g., computing device 210 may store data accessed by modules 220 and 222, and data store 226 during execution at computing device 210). In some examples, storage component 248 is a temporary memory, meaning that a primary purpose of storage component 248 is not long-term storage. Storage components 248 on computing device 210 may be configured for short-term storage of information as volatile memory and therefore not retain stored contents if powered off. Examples of volatile memories include random access memories (RAM), dynamic random access memories (DRAM), static random access memories (SRAM), and other forms of volatile memories known in the art.

Storage components 248, in some examples, also include one or more computer-readable storage media. Storage components 248 in some examples include one or more non-transitory computer-readable storage mediums. Storage components 248 may be configured to store larger amounts of information than typically stored by volatile memory. Storage components 248 may further be configured for long-term storage of information as non-volatile memory space and retain information after power on/off cycles. Examples of non-volatile memories include magnetic hard discs, optical discs, floppy discs, flash memories, or forms of electrically programmable memories (EPROM) or electrically erasable and programmable (EEPROM) memories. Storage components 248 may store program instructions and/or information (e.g., data) associated with modules 220 and 222 and data store 226. Storage components 248 may include a memory configured to store data or other information associated with modules 220 and 222, and data store 226.

Communication channels 250 may interconnect each of the components 212, 240, 242, 244, 246, and 248 for inter-component communications (physically, communicatively, and/or operatively). In some examples, communication channels 250 may include a system bus, a network connection, an inter-process communication data structure, or any other method for communicating data.

One or more communication units 242 of computing device 210 may communicate with external devices via one or more wired and/or wireless networks by transmitting and/or receiving network signals on one or more networks. Examples of communication units 242 include a network interface card (e.g. such as an Ethernet card), an optical transceiver, a radio frequency transceiver, a GPS receiver, or any other type of device that can send and/or receive information. Other examples of communication units 242 may include short wave radios, cellular data radios, wireless network radios, as well as universal serial bus (USB) controllers.

One or more input components 244 of computing device 210 may receive input. Examples of input are tactile, audio, and video input. Input components 244 of computing device 210, in one example, includes a presence-sensitive input device (e.g., a touch sensitive screen, a PSD), mouse, keyboard, voice responsive system, camera, microphone or any other type of device for detecting input from a human or machine. In some examples, input components 244 may include one or more sensor components (e.g., sensors 252). Sensors 252 may include one or more biometric sensors (e.g., fingerprint sensors, retina scanners, vocal input sensors/microphones, facial recognition sensors, cameras) one or more location sensors (e.g., GPS components, Wi-Fi components, cellular components), one or more temperature sensors, one or more movement sensors (e.g., accelerometers, gyros), one or more pressure sensors (e.g., barometer), one or more ambient light sensors, and one or more other sensors (e.g., infrared proximity sensor, hygrometer sensor, and the like). Other sensors, to name a few other non-limiting examples, may include a heart rate sensor, magnetometer, glucose sensor, olfactory sensor, compass sensor, or a step counter sensor.

One or more output components 246 of computing device 210 may generate output in a selected modality. Examples of modalities may include a tactile notification, audible notification, visual notification, machine generated voice notification, or other modalities. Output components 246 of computing device 210, in one example, includes a presence-sensitive display, a sound card, a video graphics adapter card, a speaker, a cathode ray tube (CRT) monitor, a liquid crystal display (LCD), a light emitting diode (LED) display, an organic LED (OLED) display, a virtual/augmented/extended reality (VR/AR/XR) system, a three-dimensional display, or any other type of device for generating output to a human or machine in a selected modality.

UI component 212 of computing device 210 may be similar to UI component 112 of computing device 110 and includes display component 202 and presence-sensitive input component 204. Display component 202 may be a screen, such as any of the displays or systems described with respect to output components 246, at which information (e.g., a visual indication) is displayed by UI component 212 while presence-sensitive input component 204 may detect an object at and/or near display component 202.

While illustrated as an internal component of computing device 210, UI component 212 may also represent an external component that shares a data path with computing device 210 for transmitting and/or receiving input and output. For instance, in one example, UI component 212 represents a built-in component of computing device 210 located within and physically connected to the external packaging of computing device 210 (e.g., a screen on a mobile phone). In another example, UI component 212 represents an external component of computing device 210 located outside and physically separated from the packaging or housing of computing device 210 (e.g., a monitor, a projector, etc. that shares a wired and/or wireless data path with computing device 210).

UI component 212 of computing device 210 may detect two-dimensional and/or three-dimensional gestures as input from a user of computing device 210. For instance, a sensor of UI component 212 may detect a user's movement (e.g., moving a hand, an arm, a pen, a stylus, a tactile object, etc.) within a threshold distance of the sensor of UI component 212. UI component 212 may determine a two or three-dimensional vector representation of the movement and correlate the vector representation to a gesture input (e.g., a hand-wave, a pinch, a clap, a pen stroke, etc.) that has multiple dimensions. In other words, UI component 212 can detect a multi-dimension gesture without requiring the user to gesture at or near a screen or surface at which UI component 212 outputs information for display. Instead, UI component 212 can detect a multi-dimensional gesture performed at or near a sensor which may or may not be located near the screen or surface at which UI component 212 outputs information for display.

In accordance with one or more techniques of this disclosure, UI module 220 receives, from a user, an indication of a first biometric input at sensors 252. The first biometric input may be any of a fingerprint input, a voice input, a facial recognition input, and a retina input.

Biometric module 222 determines that the first biometric input matches a first predetermined biometric input of a verification sequence in rules 226. After receiving the first biometric input, UI module 220 provides a first prompt to the user via UI component 212. The first prompt includes a first request for at least one of a next biometric input user selection and a complete verification sequence user selection. In some examples, the first prompt is a visual prompt provided UI component 212 of computing device 210, while the prompt may be an audible prompt in other examples.

If UI module 22 receives the complete verification sequence user selection at this point, or at any point before when the biometric verification sequence is incomplete, has received too many inputs, or the order was completed incorrectly, biometric module 222 may prohibit enablement of computing device 210 to receive a user command. In other words, rather than simply verifying a biometric signature, biometric module 222 also verifies the order in which the biometric inputs are received as part of the overall verification process. Should biometric module 222 verify each of the biometric inputs as matching the predetermined biometric signature but also determine that the biometric inputs were entered in an order different than the predetermined verification sequence, biometric module 222 may prohibit enablement of computing device 210 to receive a user command.

UI module 220 may receive, from the user, the next biometric input user selection in response to the first prompt. UI module 220 may receive, from the user, an indication of a second biometric input at sensors 252. The second biometric input may be any of a fingerprint input, a voice input, a facial recognition input, and a retina input, regardless of what the first biometric input consisted of For instance, the first and second biometric inputs may both be fingerprint inputs, the first biometric input may be a fingerprint input and the second biometric input may be one of a voice input, a facial recognition input, or a retina input, or the first biometric input may be a retina input and the second biometric input may be a voice input. The first and second biometric inputs may be any combination of biometric inputs described herein.

Biometric module 222 may determine that the second biometric input matches a second predetermined biometric input of a verification sequence. After receiving the second biometric input, UI module 220 provides a second prompt to the user via UI component 212. The second prompt includes a second request for at least one of the next biometric input user selection and the complete verification sequence user selection. In some examples, the second prompt is a visual prompt provided UI component 212 of computing device 210, while the second prompt may be an audible prompt in other examples.

UI module 220 receives, from the user, the complete verification sequence user selection in response to the second prompt. After receiving the complete verification sequence user selection, and upon biometric module 222 determining that at least the first biometric input matches the first predetermined biometric input of the verification sequence, the second biometric input matches the second predetermined biometric input of the verification sequence, and an order in which the first biometric input and the second biometric input is received matches a predetermined biometric input order for the first biometric input and the second biometric input required by the verification sequence, biometric module 222 enables computing device 210 to receive a user command.

In some instances, the predetermined biometric input order required by the verification sequence includes the first biometric input being received before the second biometric input. In such instances, when UI module 220 receives the second biometric input before the first biometric input, biometric module 222 may prohibit enablement of computing device 210 to receive a user command.

In some examples, in enabling computing device 210 to receive the user command, biometric module 222 may unlock computing device 210. For instance, computing device 210 may be a control panel for a premise security system. When the control panel is set to an armed mode prior to UI module 220 receiving each of the first biometric input and the second biometric input, biometric module 222, upon verifying the biometric inputs and the order of the biometric inputs, may either set the control panel to an unarmed mode or may unlock the control panel such that the user may set the control panel to the unarmed mode.

In some instances, biometric module 222 may require that the biometric verification process is repeated to provide an additional layer of security and to lower the chances of a false positive biometric authentication. For instance, after UI module 220 receives the complete verification sequence user selection, and upon biometric module 222 determining that at least the first biometric input matches the first predetermined biometric input of the verification sequence, the second biometric input matches the second predetermined biometric input of the verification sequence, and the order in which the first biometric input and the second biometric input is received matches the predetermined biometric input order, UI module 220 may provide a verification prompt to the user. The verification prompt may include a request to repeat the first biometric input and the second biometric input.

UI module 220 and biometric module 222 may then repeat the process, receiving first and second repeat biometric inputs and determining the validity of the repeat biometric inputs. After UI module 220 receives the repeat first biometric input and the repeat second biometric input, and upon biometric module 222 determining that at least the repeat first biometric input matches the first predetermined biometric input of the verification sequence, the repeat second biometric input matches the second predetermined biometric input of the verification sequence, and an order in which the repeat first biometric input and the repeat second biometric input is received matches the predetermined biometric input order for the first biometric input and the second biometric input required by the verification sequence, biometric module 222 may then enable the computing device to receive the user command.

While the above example is shown with only two biometric inputs, it should be understood that the verification sequence can include more biometric inputs. For instance, the biometric verification sequence may include three, four, five, or any number of predetermined biometric inputs. In such instances, UI module 220 may receive the next biometric input user selection multiple times, UI module 220 may receive any number of indications of biometric inputs from the user, and biometric module 222 may compare every received biometric input with each predetermined biometric input in the predetermined biometric verification sequence. Biometric module 222 may also verify that the order of the any number of biometric inputs was the correct order for the predetermined biometric verification sequence, thereby creating an open-ended and indeterminate-length passcode of biometric information. This even further enhances the security of the system, as an intruder must have the fraudulent biometric information to satisfy the system but must also input the biometric inputs in the correct order and must input the correct amount of biometric inputs.

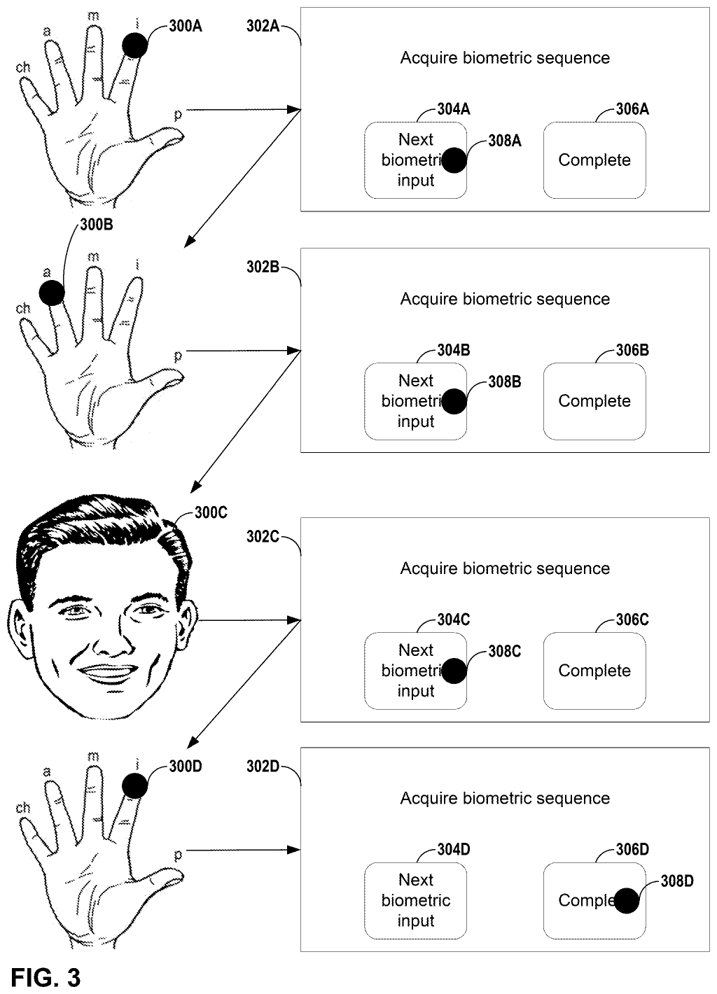

FIG. 3 is a conceptual diagram illustrating a sequence of biometric inputs, in accordance with one or more techniques of this disclosure. For the purposes of this disclosure, any of inputs 300A-300D can be considered to have been received at one of sensors 152 of FIG. 1 or sensors 252 of FIG. 2. Furthermore, any of prompts 302A-302D can be considered to have been output by one of computing device 110 or computing device 210 for display on, or audibly by, UI component 112 or UI component 212, respectively. Inputs 300A-300D and prompts 302A-302D are mere examples of a potential sequence operating in accordance with the techniques described herein, and it should be understood that other sequences, other prompt configurations, and other biometric inputs could be used for similar verification sequences in accordance with the techniques described herein.

As shown in FIG. 3, a user may first provide input 300A into the system, which corresponds to a fingerprint of pointer finger “i” of the user's right hand. In response to receiving input 300A, the computing device may output prompt 302A, requesting either next biometric input user selection 304A or complete verification sequence user selection 306A. The user may wish to continue providing biometric signatures to complete the predetermined sequence, so the user may input selection 308A of next biometric input user selection 304A.

After selecting next biometric input user selection 304A with selection 308A, the user may provide input 300B into the system, which corresponds to a fingerprint of ring finger “a” of the user's right hand. In response to receiving input 300B, the computing device may output prompt 302B, requesting either next biometric input user selection 304B or complete verification sequence user selection 306B. The user may wish to continue providing biometric signatures to complete the predetermined sequence, so the user may input selection 308B of next biometric input user selection 304B.

After selecting next biometric input user selection 304B with selection 308B, the user may provide input 300C into the system, which corresponds to a facial recognition scan of the user's face. In response to receiving input 300C, the computing device may output prompt 302C, requesting either next biometric input user selection 304C or complete verification sequence user selection 306C. The user may wish to continue providing biometric signatures to complete the predetermined sequence, so the user may input selection 308C of next biometric input user selection 304C.

After selecting next biometric input user selection 304C with selection 308C, the user may provide input 300D into the system, which corresponds to a fingerprint of pointer finger “i” of the user's right hand (similar to input 300A). In this way, the biometric verification sequence described herein may repeat biometric inputs during the verification process. In response to receiving input 300D, the computing device may output prompt 302D, requesting either next biometric input user selection 304D or complete verification sequence user selection 306D. The user may believe that they have completed the proper predetermined sequence, so the user may input selection 308D of complete verification sequence user selection 306D. The computing device may analyze each of inputs 300A-300D to verify that the inputs match the biometric signature stored in a rules data store for the particular user, as well as verify the order in which inputs 300A-300D were input to verify that the order matches the predetermined biometric verification sequence. Should inputs 300A-300D match the biometric signatures and should the order of inputs 300A-300D match the biometric verification sequence, the computing device may grant access for the user to input commands into the computing device or may complete a previously input command.

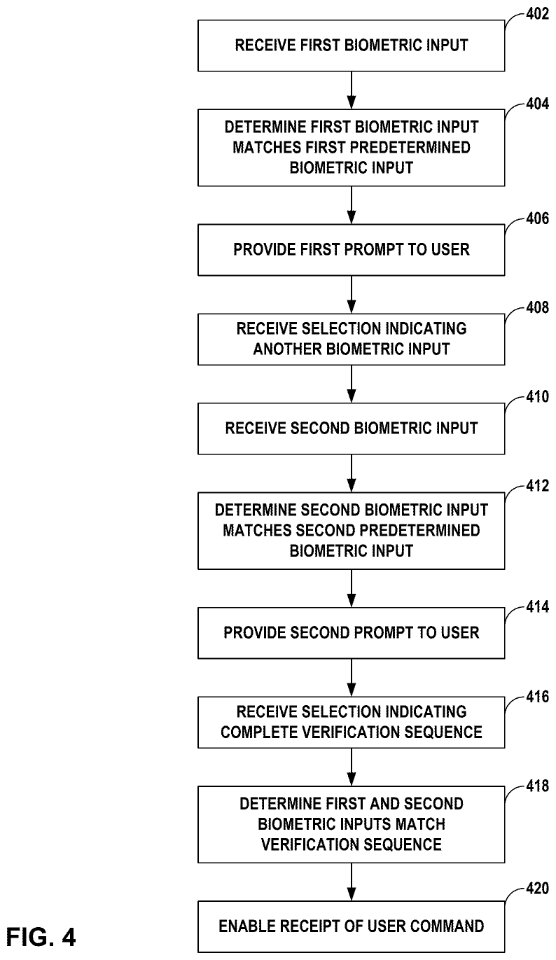

FIG. 4 is a flowchart illustrating an example biometric authorization technique in accordance with the techniques described herein. The techniques of FIG. 4 may be performed by one or more processors of a computing device, such as system 100 of FIG. 1 and/or computing device 210 illustrated in FIG. 2. For purposes of illustration only, the techniques of FIG. 4 are described within the context of computing device 210 of FIG. 2, although computing devices having configurations different than that of computing device 210 may perform the techniques of FIG. 4.

In accordance with one or more techniques of this disclosure, UI module 220 receives, from a user, a first biometric input at sensors 252 (402). Biometric module 222 determines that the first biometric input matches a first predetermined biometric input of a verification sequence in rules 226 (404). After receiving the first biometric input, UI module 220 provides a first prompt to the user via UI component 212 (406). The first prompt includes a first request for at least one of a next biometric input user selection and a complete verification sequence user selection.

UI module 220 receives, from the user, the next biometric input user selection in response to the first prompt (408). UI module 220 receives, from the user, a second biometric input at sensors 252 (410). Biometric module 222 determines that the second biometric input matches a second predetermined biometric input of a verification sequence (412). After receiving the second biometric input, UI module 220 provides a second prompt to the user via UI component 212 (414). The second prompt includes a second request for at least one of the next biometric input user selection and the complete verification sequence user selection.

UI module 220 receives, from the user, the complete verification sequence user selection in response to the second prompt (416). After receiving the complete verification sequence user selection, and upon biometric module 222 determining that at least the first biometric input matches the first predetermined biometric input of the verification sequence, the second biometric input matches the second predetermined biometric input of the verification sequence, and an order in which the first biometric input and the second biometric input is received matches a predetermined biometric input order for the first biometric input and the second biometric input required by the verification sequence (418), biometric module 222 enables computing device 210 to receive a user command (420).

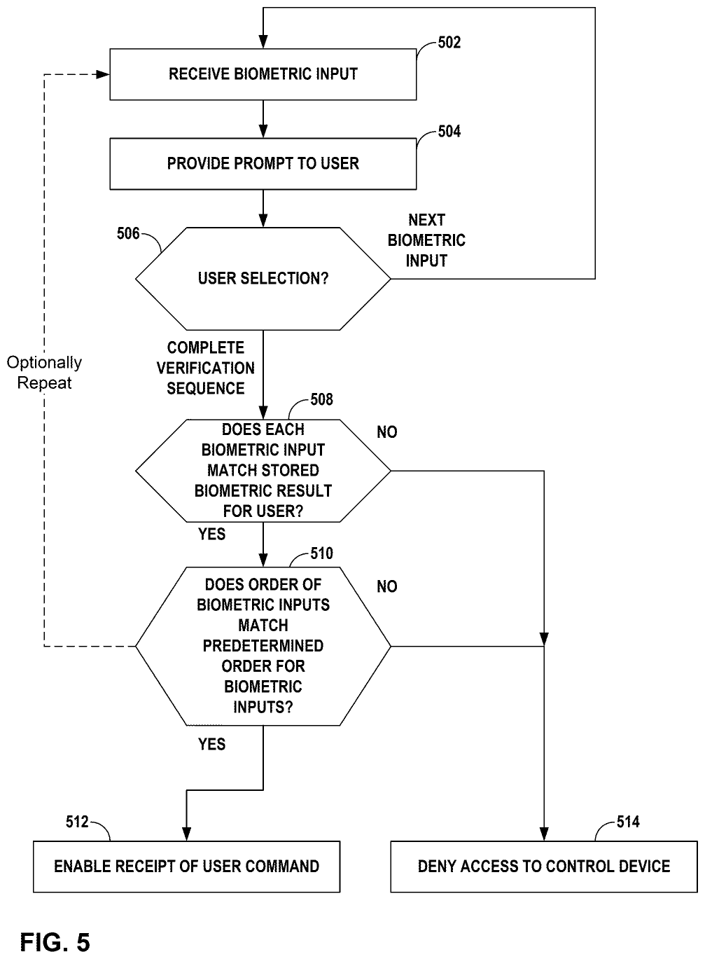

FIG. 5 is a flow chart illustrating an example biometric authorization technique in accordance with the techniques described herein. The techniques of FIG. 5 may be performed by one or more processors of a computing device, such as system 100 of FIG. 1 and/or computing device 210 illustrated in FIG. 2. For purposes of illustration only, the techniques of FIG. 5 are described within the context of computing device 210 of FIG. 2, although computing devices having configurations different than that of computing device 210 may perform the techniques of FIG. 5.

In accordance with one or more techniques of this disclosure, UI module 220 may receive an indication of user input that includes a biometric signature at sensors 252 (502). UI module 220 then provides a prompt to the user via UI component 212 (504), the prompt including a request for at least one of a next biometric input user selection and a complete verification sequence user selection.

UI module 220 receives an indication of a second user input indicating a user selection in response to the prompt (506). If UI module 220 determines that the indication of second user input indicates a user selection of a next biometric input user selection (“NEXT BIOMETRIC INPUT” branch of 506), UI module 220 receives another indication of user input that includes a biometric signature at sensors (502) and provides the prompt to the user via UI component 212 (504) again. UI module 220 repeats this process until UI module 220 determines that the indication of user input indicates a selection of a complete verification sequence user selection (“COMPLETE VERIFICATION SEQUENCE” branch of 506).

In response to receiving the complete verification sequence user selection, biometric module 222 determines whether each received biometric signature matches a stored biometric result for the particular user to first verify that each user input is valid (508). If biometric module 222 determines that one or more biometric signatures do not match a stored biometric result for the particular user (“NO” branch of 508), biometric module 222 denies the user access to computing device 210 (514). If biometric module 222 determines that every biometric signature does match a stored biometric result for the particular user (“YES” branch of 508), biometric module 222 determines whether the order of biometric inputs matches the predetermined order for the biometric inputs (510). If biometric module 222 determines that the order of biometric inputs does not match the predetermined order for biometric inputs (“NO” branch of 510), biometric module 222 denies the user access to computing device 210 (514). Conversely, if biometric module 222 determines that the order of biometric inputs does match the predetermined order for biometric inputs (“YES” branch of 510), biometric module 222 grants user access to computing device 210 and enables the receipt of a user command (512).

It is to be recognized that depending on the example, certain acts or events of any of the techniques described herein can be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some aspects, the functionality described herein may be provided within dedicated hardware and/or software modules configured for encoding and decoding, or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various examples of the disclosure have been described. Any combination of the described systems, operations, or functions is contemplated. These and other examples are within the scope of the following claims.

What is claimed is:

1. A method comprising the steps of:
receiving, from a user, a first biometric input at a computing device;
determining that the first biometric input matches a first predetermined biometric input of a verification sequence;
after receiving the first biometric input at the computing device, providing a first prompt to the user, the first prompt including a first request for at least one of a next biometric input user selection and a complete verification sequence user selection;
receiving, from the user, the next biometric input user selection in response to the first prompt;
receiving, from the user, a second biometric input at the computing device;
determining that the second biometric input matches a second predetermined biometric input of a verification sequence;
after receiving the second biometric input at the computing device, providing a second prompt to the user, the second prompt including a second request for at least one of the next biometric input user selection and the complete verification sequence user selection;
receiving, from the user, the complete verification sequence user selection in response to the second prompt; and
after i) receiving the complete verification sequence user selection, and ii) upon determining that at least the first biometric input matches the first predetermined biometric input of the verification sequence, the second biometric input matches the second predetermined biometric input of the verification sequence, and an order in which the first biometric input and the second biometric input is received matches a predetermined biometric input order for the first biometric input and the second biometric input required by the verification sequence, enabling the computing device to receive a user command.

2. The method of claim 1, wherein the predetermined biometric input order required by the verification sequence includes the first biometric input being received before the second biometric input.

3. The method of claim 2, wherein, when the second biometric input is received before the first biometric input, prohibiting enablement of the computing device to receive a user command.

4. The method of claim 1, wherein the first biometric input comprises a first fingerprint input and the second biometric input comprises a second fingerprint input.

5. The method of claim 1, wherein each of the first biometric input and the second biometric input is selected from the group consisting of: a fingerprint input, a voice input, a facial recognition input, and a retina input.

6. The method of claim 1, wherein one of the first biometric input and the second biometric input comprises a fingerprint input and the other of the first biometric input and the second biometric input is selected from the group consisting of: a voice input, a facial recognition input, and a retina input.

7. The method of claim 1, wherein enabling the computing device to receive the user command comprises unlocking the computing device.

8. The method of claim 7, wherein the computing device is a control panel for a premise security system, and wherein the control panel is set to an armed mode prior to receiving each of the first biometric input and the second biometric input.

9. The method of claim 1, further comprising:
after i) receiving the complete verification sequence user selection, and ii) upon determining that at least the first biometric input matches the first predetermined biometric input of the verification sequence, the second biometric input matches the second predetermined biometric input of the verification sequence, and the order in which the first biometric input and the second biometric input is received matches the predetermined biometric input order, providing a verification prompt to the user, the verification prompt including a request to repeat the first biometric input and the second biometric input; and
after i) receiving a repeat first biometric input and a repeat second biometric input, and ii) upon determining that at least the repeat first biometric input matches the first predetermined biometric input of the verification sequence, the repeat second biometric input matches the second predetermined biometric input of the verification sequence, and an order in which the repeat first biometric input and the repeat second biometric input is received matches the predetermined biometric input order for the first biometric input and the second biometric input required by the verification sequence, enabling the computing device to receive the user command.

10. The method of claim 1, wherein, in response to receiving the complete verification sequence user selection before receiving the second biometric input, prohibiting enablement of the computing device to receive a user command.

11. The method of claim 1, wherein the first prompt is a visual prompt provided at the computing device, and wherein the second prompt is a visual prompt provided at the computing device.

12. A non-transitory computer-readable storage medium comprising computer-executable instructions that, when executed by one or more processors of a computing device, cause the one or more processors to:
receive, by one or more processors of the computing device, a first biometric input;
determine, by the one or more processors of the computing device, that the first biometric input matches a first predetermined biometric input of a verification sequence;
after receiving the first biometric input, provide, by the one or more processors of the computing device, a first prompt, the first prompt including a first request for at least one of a next biometric input user selection and a complete verification sequence user selection;
receive, by the one or more processors of the computing device, the next biometric input user selection in response to the first prompt;
receive, by the one or more processors of the computing device, a second biometric input;
determine, by the one or more processors of the computing device, that the second biometric input matches a second predetermined biometric input of a verification sequence;
after receiving the second biometric input, provide, by the one or more processors of the computing device, a second prompt to the user, the second prompt including a second request for at least one of the next biometric input user selection and the complete verification sequence user selection;
receive, by the one or more processors of the computing device, the complete verification sequence user selection in response to the second prompt; and
after i) receiving, by the one or more processors of the computing device, the complete verification sequence user selection, and ii) upon determining, by the one or more processors of the computing device, that at least the first biometric input matches the first predetermined biometric input of the verification sequence, the second biometric input matches the second predetermined biometric input of the verification sequence, and an order in which the first biometric input and the second biometric input is received matches a predetermined biometric input order for the first biometric input and the second biometric input required by the verification sequence, enable, by the one or more processors of the computing device, receipt of a user command.

13. The non-transitory computer-readable storage medium of claim 12, wherein the predetermined biometric input order required by the verification sequence includes the first biometric input being received before the second biometric input.

14. The non-transitory computer-readable storage medium of claim 13, wherein, when the second biometric input is received before the first biometric input, prohibit, by the one or more processor of the computing device, receipt of a user command.

15. The non-transitory computer-readable storage medium of claim 12, wherein each of the first biometric input and the second biometric input is selected from the group consisting of: a fingerprint input, a voice input, a facial recognition input, and a retina input.

16. The non-transitory computer-readable storage medium of claim 12, wherein one of the first biometric input and the second biometric input comprises a fingerprint input and the other of the first biometric input and the second biometric input is selected from the group consisting of: a voice input, a facial recognition input, and a retina input.

17. The non-transitory computer-readable storage medium of claim 12, wherein enabling, by the one or more processors of the computing device, receipt of the user command comprises unlocking the computing device.

18. The non-transitory computer-readable storage medium of claim 17, wherein the computing device is a control panel for a premise security system, and wherein the control panel is set to an armed mode prior to receiving each of the first biometric input and the second biometric input.

19. The non-transitory computer-readable storage medium of claim 12, wherein executing the computer-executable instructions by the one or more processors of the computing device further causes the one or more processors to:
after i) receiving, by the one or more processors of the computing device, the complete verification sequence user selection, and ii) upon determining, by the one or more processors of the computing device, that at least the first biometric input matches the first predetermined biometric input of the verification sequence, the second biometric input matches the second predetermined biometric input of the verification sequence, and the order in which the first biometric input and the second biometric input is received matches the predetermined biometric input order, provide, by the one or more processors of the computing device, a verification prompt to the user, the verification prompt including a request to repeat the first biometric input and the second biometric input; and
after i) receiving, by the one or more processors of the computing device, a repeat first biometric input and a repeat second biometric input, and ii) upon determining, by the one or more processors of the computing device, that at least the repeat first biometric input matches the first predetermined biometric input of the verification sequence, the repeat second biometric input matches the second predetermined biometric input of the verification sequence, and an order in which the repeat first biometric input and the repeat second biometric input is received matches the predetermined biometric input order for the first biometric input and the second biometric input required by the verification sequence, enable, by the one or more processors of the computing device, receipt of the user command.

20. The non-transitory computer-readable storage medium of claim 12, wherein, in response to receiving, by the one or more processors of the computing device, the complete verification sequence user selection before receiving the second biometric input, prohibit, by the one or more processors of the computing device, receipt of the user command.
